(19) United States
(12) Patent Application Publication
(10) Pub. No.: US 2009/0133771 A1
(43) Pub. Date: May 28, 2009

(54) Method and Apparatus for Making Plastic Drainage Pipe Reinforced By Steel Strips and the Plastic Drainage Pipe Reinforced By Steel

(76) Inventor: Yiliang He, Heilongjiang (CN)

Correspondence Address: MCDERMOTT WILL & EMERY LLP, 600 13TH STREET, N.W., WASHINGTON, DC, 20005-3096, US

(21) Appl. No.: 11/988,371

(22) PCT Filed: Jul. 7, 2006
(86) PCT No.: PCT/CN2006/001607

§ 371 Date: Sep. 30, 2008

(30) Foreign Application Priority Data
Jul. 7, 2005 (CN) 2005100829114

(51) Int. Cl. F16L 11/00; F16L 9/06

(52) U.S. Cl. 138/129; 138/173; 264/296; 138/122; 138/133

(57) ABSTRACT

The present invention relates to a method for making a plastic drainage pipeline reinforced by steel strips, comprising the steps of (1) steel strips and plastic being integrated to form a composite profile having ribs reinforced by steel strips; (2) the composite profiles being transported to an installation site; (3) the composite profiles being wound, and simultaneously the edge of the profile being melted and welded to form plastic drainage pipes reinforced by steel strips; and (4) a spigot joint being made at one end of the pipe. The present invention also relates to a plastic drainage pipe made by the method, comprising a plastic pipe body and reinforcing ribs integrated with the plastic pipe body as a whole, wherein the ribs of the plastic pipe are reinforced by steel strips enwrapped by the plastic. The present invention also provides an apparatus for making the plastic drainage pipe reinforced by steel strips.

### FILED OF THE INVENTION

The present invention relates to a plastic drainage pipe reinforced by steel strips, as well as a method and apparatus for making the drainage pipe. More particularly, the present invention relates to a drainage pipe made from a composite profile that is formed by integrating plastic with steel strips by means of an integration machine, through a winding and welding process by means of a special winding and welding machine.

### BACKGROUND OF INVENTION

The prior art plastic drainage pipes are all developed for non-pressure applications. For the purpose of saving materials while ensuring the hoop rigidity of the pipe in service, various kinds of pipes with different structures, such as dual-wall corrugated pipe and spirally wound hollow wall pipe, were invented. Nowadays, structural wall pipes, which are much lighter than solid wall pipes, are relatively mature for common applications. The shortcoming of such plastic pipes lies in that the pipe should be made at a factory and then transported to installation sites. Moreover, these kinds of structural wall plastic pipes are plastic-pure pipes, which involve high costs due to raw materials and transportation. From publicly available information, two methods are known to have been used for making spirally wound plastic pipes. According to one method, a plastic melt strip is continuously wound, welded and cooled down to form the pipe, while according to the other, a plastic profile is formed first and cooled down, and then the plastic profile is wound and welded by means of a special winding machine to form a pipe with a smooth bore. The two methods mentioned above are relatively sophisticated, but till now, they can not be used to make pipes other than plastic-pure ones.

Japanese patent No. JP9310788A disclosed a pipe made by winding steel (or other reinforcing element) reinforced plastic profile, of which the profile is made by means of a two-step process. The first step involves formation of a plastic-pure profile with ribs extending from the basic portion, and the ribs have slots opening to the inside of the pipe to be formed. The second step involves winding and inserting steel strips to the slots to form steel strip reinforced composite profile. The two-step profile making process is too complicated with low efficiency. In addition, the steel strip and plastic are not integrated in the profile. The pipe formed with this kind of profile can not provide satisfactory strength and hoop rigidity, and measures have to be taken to keep the exposed steel strip from contacting the medium inside.

Patent No. WO2003/089226 disclosed a similar spirally-wound steel strip reinforced plastic pipe, which is different from the pipe described in Japanese patent No. JP9310788A in that the slot opens to the outside of the pipe to be formed, but the composite profile is still made by means of a two-step process.

### SUMMARY OF THE INVENTION

The objective of the present invention is to provide a plastic drainage pipe reinforced by steel strips, wherein the steel strip is enwrapped in plastic ribs and closely integrated with the plastic ribs.

The other objective of the present invention is to provide a method and apparatus for making the plastic drainage pipe reinforced by steel strips.

To achieve the above objectives, a drainage pipe provided by the present invention comprises a plastic pipe body and reinforcing ribs integrated with the plastic pipe body as a whole, wherein the ribs of the plastic pipe are reinforced by steel strips enwrapped by the plastic; the pipe body further includes a spigot joint at one end of the pipe for jointing the pipes to each other; and the spigot joint comprises a jointing part where a sealing rubber ring is to be fixed or a sealant is to be used.

The method for making a plastic drainage pipe reinforced by steel strips provided by the present invention comprises the following steps:
1. the steel strips and plastic are integrated together to form a composite profile having ribs reinforced by steel strips by means of a one-step process;
2. the composite profile is transported to an installation site;
3. the composite profile is wound, and simultaneously the edge of the profiles are heated and welded together to form a plastic pipe reinforced by the steel strips;
4. a spigot joint is made at one end of the pipe.

The apparatus for making the plastic drainage pipe provided by the present invention includes:
1. an integration device for making a composite profile having ribs reinforced by steel strips by means of one-step integration process;
2. a winding and welding device for winding and welding the composite profile to form a plastic drainage pipe reinforced by steel strips;
3. a device for making a spigot joint at one end of the pipe.

In comparison with the prior plastic pipes of the same diameter, the pipe made according to the method and apparatus of the present invention is lighter, consequently, raw materials are saved while the service performances are ensured. Moreover, the pipe according to the present invention can be made at installation sites to save transportation cost effectively.

The other objectives and merits of the present invention are described in the following embodiments in accompanying with the drawings.

### BRIEF DESCRIPTION OF THE DRAWINGS

FIG. 1 is a top view, showing the means for making a composite profile in one-step mode according to the present invention;

FIG. 2 is a cross-sectional view, showing a composite profile reinforced by steel strips according to the present invention;

FIG. 3 is a view, showing the winding and welding apparatus which is used to wind and weld the composite profile to form a plastic drainage pipe reinforced by steel strips according to the present invention;

FIG. 4 is a view taken along A-A line in FIG. 3.

FIG. 5 is a view, showing a means for making the spigot joint at the pipe end according to the present invention.

### PREFERRED EMBODIMENTS

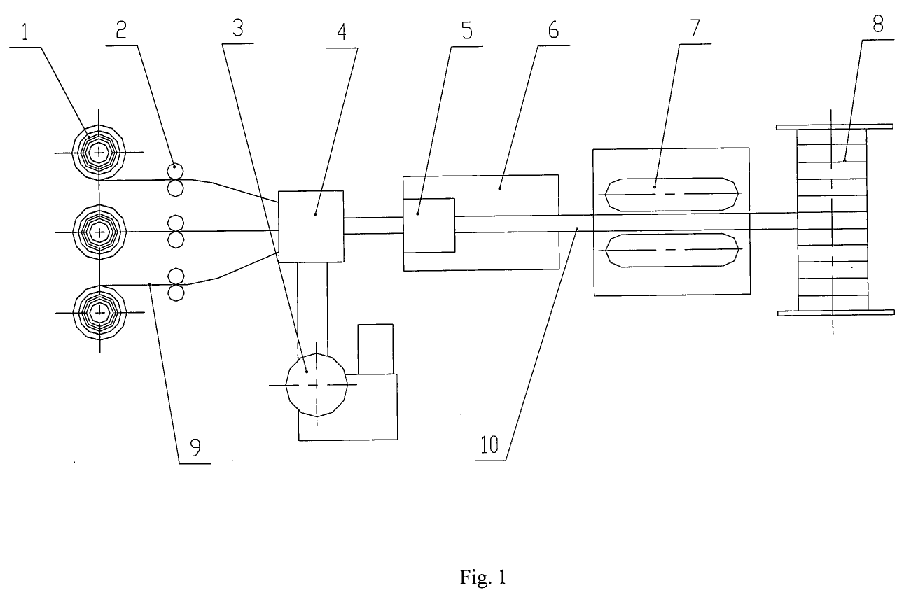

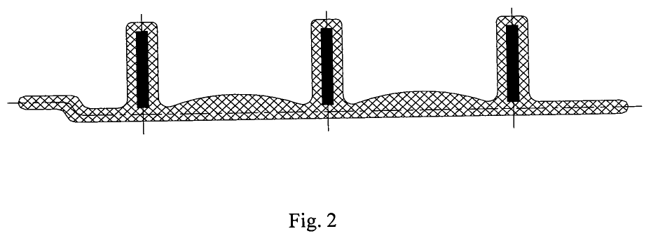

The one-step integration mode is described below in accompanying with FIG. 1.

FIG. 1 shows uncoiling device 1, guide roll 2, extruder 3, integration mold 4, vacuum sizing mold 5, cooling water tank 6, haul off machine 7, coiling machine 8, steel strip 9 and composite profile 10.

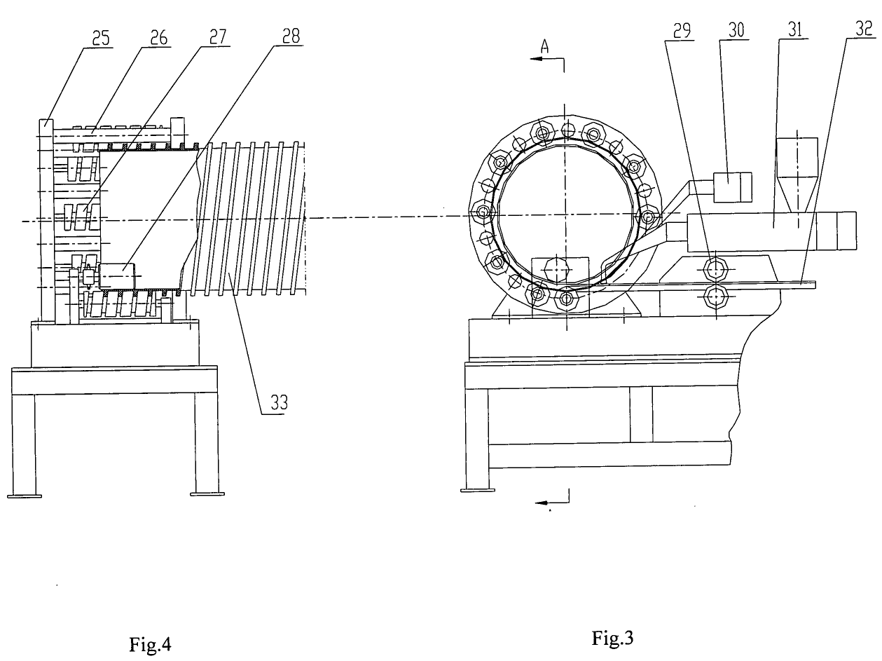

With reference to FIG. 1, steel strips 9 are hauled off from uncoiling device 1 by haul off machine 7 and fed into integration mold 4 (key part of the extruding and integrating process) by means of the guidance of guide roll 2. The integration mold 4 is connected with the head of extruder 3 perpendicularly. The shape of the inner cavity of the integration mold 4 corresponds to that of the composite profile 10. When the steel strips 9 go through the integration mold 4, the extruder 3 extrudes plastic melt into the integration mold 4 so that steel strips 9 are enwrapped by the plastic melt inside the integration mold 4. Soft composite profile 10 is pulled out of the integration mold 4 by the pulling force of the haul off machine 7. Under continuous pulling action of the haul off machine, the soft composite profile keeps going ahead and becomes cooled down when moving through the vacuum sizing mold 5 and then further cooled down to reach the room temperature when moving through water cooling tank 6, and finally finished composite profile 10 with reinforced steel strips as shown in FIG. 3 is formed. Then the composite profile 10 is coiled into a reel by the coiling machine 8. Now the profile reels are ready to be used by the winding and welding machine to make the pipe.

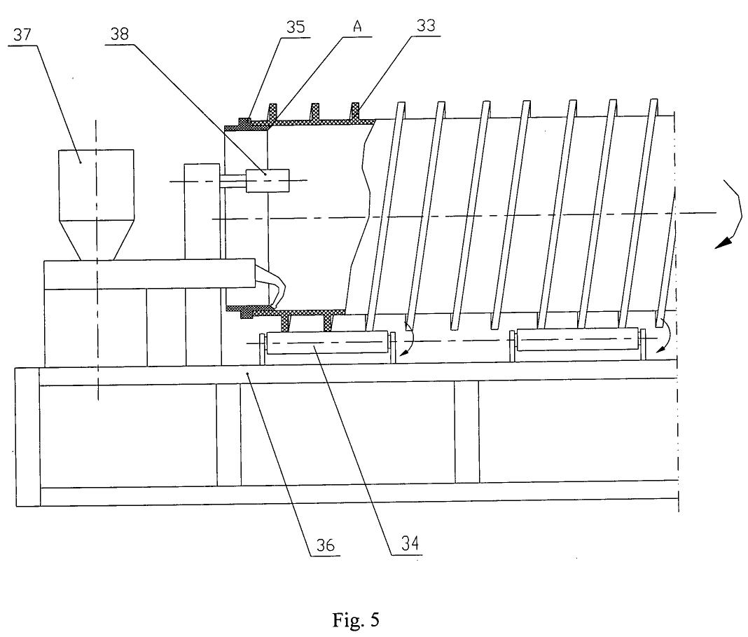

FIG. 3 and FIG. 4 show the winding and welding apparatus for winding and welding the composite profile to make steel strip reinforced plastic drainage pipe 33. The winding and welding apparatus shown in FIG. 3 and FIG. 4 includes frame 25, un-grooved roller 26, grooved roller 27, press roller 28, feeding roller 29, hot air blower 30, small extruder 31, composite profile 32, and plastic drainage pipe 33 formed by winding and welding process.

With reference to FIG. 3 and FIG. 4, the basic winding and welding process to make plastic drainage pipe 33 reinforced by steel strips is described as follows:

The composite profile 32 is fed, through a conveying means consisting of multiple feeding rollers 29 and a press roller 28, and at a constant speed, into a “rolling cage” type winding and welding device which includes frame 25, multiple un-grooved rollers 26 and multiple grooved rollers 27. The reinforcing ribs of the composite profile 32 move along a helical passage formed by grooves of the grooved rollers 27, so that a spirally winding operation is carried out. As such a spirally winding operation is a continuous process, the composite profile 32 is continuously sent into the winding device from the tangent direction at the bottom of the “rolling cage”. Before the composite profile 32 is lapped over to the edge of the outer surfaces of the semi-finished drainage pipe 33, the surfaces of the edges to be overlapped are heated and slightly melted by hot air blower 30 while the small extruder 31 extrudes plastic melt strip to the overlapping surface, then the two surfaces are lapped over and the overlapped joint is pressed by an adjustable press roller, so that the two surfaces are surely welded together. After such a process, the overlapped edge surfaces of the composite profiles 32 are fused to each other as a whole. Finally, the plastic drainage pipe reinforced by steel strips is completed after it cools down to room temperature in the air.

Grooved rollers 27 and un-grooved rollers 26 are evenly distributed along the circumference corresponding to the diameter of the pipe, and the grooves of all grooved rollers 27 that distribute along the circumference can be connected with each other to form a helix. The distance between two grooves equals to that between two ribs in the profile, and the width of the groove corresponds to that of the rib.

FIG. 5 is a view of means for making spigot joint 35 at one end of the drainage pipe 33. The means for making spigot joint 35 as shown in FIG. 5 includes support frame 36, pipe drive roll 34, plastic extruder 37, press roller 38, spigot joint 35 and plastic drainage pipe 33. After the steel reinforced plastic drainage pipe 33 is formed, a spigot pipe end is made at one end of the drainage pipe 33, so that the drainage pipes 33 can be jointed to each other conveniently and reliably. Firstly a plastic-pure strip is made with the same plastic material as that used for making the drainage pipe; and then the plastic strip is welded to form a tube whose outside diameter should be the same as the inside diameter of the pipe; next, the tube is fixed to the end parts of the drainage pipe. When the drainage pipe takes a rotary motion at uniform speed driven by drive roll 34, the plastic extruder 37 continuously extrudes plastic melt strip to the juncture (A), then press roller 38 is used to press the juncture so that the tube is securely welded to the end part of the drainage pipe.

In addition, to ensure reliable integration between the steel strips and the plastic profile, rectangular or circular holes can be perforated on the steel strips, so that the plastic melt on both sides of the steel strips can be fused together through the holes to form integrity. For relatively thick steel strip (for instance, the thickness is equal to or larger than 2.5 mm), the surfaces of both lateral sides of the steel strip can be treated rough to improve the integration reliability between the steel strips and the plastic.

To ensure proper hoop rigidity, the width and thickness of the steel strips, as well as the distance between two steel strips can be determined according to the engineering requirements.

To prevent basic plastic portion between two ribs from being damaged by sharp objects such as rocks, stones etc. during pipe laying, the plastic part between the ribs is not supposed to be flat. On the contrary, the plastic part between two ribs should have a convex shape or be thicker than the rest of the drainage pipe.

To ensure the production speed, profiles with different width may be used for production of pipes with different diameters.

1. A method for making plastic drainage pipeline reinforced by steel strips characterized in that it comprises the following steps:
Step 1, steel strips and plastic are integrated to form a composite profile having ribs reinforced by steel strips by means of a one-step process;
Step 2, the composite profiles are transported to an installation site;
Step 3, the composite profiles are spirally wound, and simultaneously the edge of the profile is melted and welded to form plastic drainage pipes reinforced by steel strips; and
Step 4, a spigot joint is made at one end of the pipe.

2. The method according to claim 1, characterized in that the steel strips (9) are firstly hauled off from uncoiling device (1) by haul off machine (7) and fed into integration mold (4) by means of the guidance of guide roll (2); when the steel strips (9) go through the integration mold (4), the extruder (3) extrudes plastic melt into the integration mold (4) so that steel strips (9) are enwrapped by the plastic melt inside integration mold (4) to form a soft composite profile (10); the soft composite profile (10) comes out from the integration mold (4) under the action of pulling force of the haul off machine (7); under the continuous action of the haul off machine, the soft composite profile keeps going ahead and becomes cooled down when it moves through a sizing mold (5) and is then further cooled down to reach the room temperature when moves through water cooling tank (6), and finally forms a finished composite profile (10) with reinforced steel strips; and then the composite profile 10 is coiled into a reel by the coiling machine (8); wherein said integration mold (4) is connected to the extruder (3) perpendicularly and the inner cavity of the integration mold (4) has a shape corresponding to that of the composite profile (10).

3. The method according to claim 1 or claim 2, characterized in that in step 3, the composite profile (32) is sent, through a conveying means consisting of multiple feeding rollers (29) and a press roller (28), and at a constant speed, into a “rolling cage” type winding and welding device which includes frame (25), multiple flat rollers (26) and multiple grooved rollers (27); the reinforcing ribs of the composite profile (32) move along a helical passage formed by grooves of grooved rollers (27), so that a spirally winding operation is carried out; as the spirally winding is continuously operated, the composite profile (32) is continuously sent into the winding device in the tangent direction at the bottom of “rolling cage”; before the composite profile (32) is lapped over to the edge of the outer surfaces of the drainage pipe (33), the overlapped surfaces are heated and slightly melted by hot air blower (30) while a small extruder (31) extrudes plastic melt strip to the overlapped joint, then the two surfaces are lapped over and the overlapped joint is pressed by an adjustable press roller (28), so that the overlapped edge surfaces of the composite profiles (32) are integrated with each other as a whole; and thereby the drainage pipe with ribs reinforced by steel strip is completed after it naturally cools down.

4. The method according to claim 3, characterized in that in step 4, a plastic strip is made with the same plastic as that used for making the drainage pipe; and then the plastic strip is welded to form a tube whose outside diameter is the same as the inside diameter of the pipe; the tube is fixed to the end of the drainage pipe; the plastic extruder (37) continuously extrudes plastic melt strip to the juncture (A), then press roller (38) is used to press the juncture (A) so that the tube is surely fixed to the end part of the drainage pipe to obtain a spigot joint (35).

5. An apparatus for making a drainage pipe reinforced by steel strips, characterized in that the apparatus comprises:
(1) an integration device for forming the composite profile having ribs reinforced by steel strips by means of a one-step process;
(2) a winding and welding device for winding and welding the composite profile to form the plastic drainage pipe reinforced by steel strips; and
(3) a device for making the spigot joint at one end of the drainage pipe.

6. The apparatus according to claim 5, characterized in that the integration device comprises:
a haul off machine (7), for pulling steel strips (9) from uncoiling device (1) and feeding the steel strips into integration mold (4) by means of the guidance of guide roll (2); an extruder (3), which is perpendicularly positioned and connected to the integration mold(4); a sizing mold (5) and a water cooling tank (6) for sizing and cooling down the composite profile (10) with reinforcing steel strips; and a coiling machine (8) for coiling the cooled down composite profile (10) into a reel.

7. The apparatus according to claim 5, characterized in that the winding and welding device comprises:
multiple feeding rollers (29), for sending the composite profile (32) to the winding and welding device; a press roller (28), for exerting pressure to turn the composite profile (32) to round shape and to make the overlapping edges of the composite profile (32) contact each other closely; a hot air blower (30), for heating and slightly melting the surface of the overlapping edges of the composite profile (32) and the drainage pipe (33); a small extruder (31), for extruding plastic melt strip to the overlapped joint; multiple un-grooved rollers (26) and multiple grooved rollers (27), constitute part of a “rolling cage” type winding and welding device, for making the composite profile (32) move along a helical passage formed by grooves of grooved rollers (27) continuously and pushing the finished steel trip reinforced plastic drainage pipe (33) out of the winding and welding device

8. The apparatus according to claim 5, characterized in that the device for making spigot joint comprises:
support frame (36), pipe drive roll (34), plastic pipe reinforced by steel strips (33), spigot joint (35) fixed at the end part of the drainage pipe (33), extruder (37) for extruding plastic melt strip to the juncture A of the overlap joint, and press roller (38) for pressing the juncture (A).

9. A plastic drainage pipe reinforced by steel strips made by the method according to claim 1, comprising a plastic pipe body and reinforcing ribs integrated with the plastic pipe body as a whole, wherein the ribs of the plastic pipe are reinforced by steel strips enwrapped by the plastic; the pipe body further includes a spigot joint at one end of the pipe for jointing the pipes to each other; and the spigot joint comprises a jointing part where a sealing rubber ring is to be fixed or a sealant is to be used; the plastic part between two ribs has a convex shape; rectangular or circular holes can be perforated on the steel strips, and the surfaces of both lateral sides of the steel strip can be treated rough, so as to improve the integration reliability between the steel strips and the plastic.

10. A plastic profile reinforced by steel strips made by the method according to claim 1, characterized in that the ribs of the plastic profile are reinforced by steel strips enwrapped by the plastic; the plastic part between two ribs has a convex shape; rectangular or circular holes can be perforated on the steel strips, and the surfaces of both lateral sides of the steel strip can be treated rough, so as to improve the integration reliability between the steel strips and the plastic.
